(19) United States
(12) Patent Application Publication
(10) Pub. No.: US 2020/0025356 A1
(43) Pub. Date: Jan. 23, 2020

(54) CEILING-FLUSH-MOUNTED STRUCTURAL HOLDER FOR TEMPORARY AND PERMANENT LIGHT FITTINGS

(71) Applicant: Claus HENCKEN, Düsseldorf (DE)

(72) Inventor: Claus HENCKEN, Düsseldorf (DE)

(21) Appl. No.: 16/494,037

(22) PCT Filed: Mar. 15, 2018
(86) PCT No.: PCT/EP2018/056605

§ 371 Date: Sep. 13, 2019

(30) Foreign Application Priority Data
Mar. 15, 2017 (DE) 10 2017 002 504.5

(51) Int. Cl. F21V 21/03; H02G 3/20; F21S 8/06

(52) U.S. Cl. CPC F21V 21/03; F21S 8/06; H02G 3/20

(57) ABSTRACT

The present invention relates to a novel, waisted and modular structural holder, comprising a base (7) or a base plate (7a), which base or base plate is provided with cutouts, and, in one embodiment, can be connected or is connected by latching hooks (5) and (6) to a holder (1), i.e. an illuminant holder (1), which, together with a decorative sleeve, for example 16 or 16a, produces the novel structural holder. The decorative sleeves can be of diverse configuration, for example, as shown in FIG. 1, as cylinders, if desired can also be of conical configuration or alternatively in the form of a canopy (22). The structural holder according to the invention can be fastened at the beginning in a suspended manner like a conventional structural holder with a strain relief device. Later, the structural holder, without the power connections having to be disconnected, can be fastened to a wall or ceiling because of the cutouts, the separate cables and the individual cable clamps provided according to the invention, for example clamping connectors or luster terminals, and all of the power lines can be looped, in particular tightly, around the arm (8) of a base unit (7-9), which forms a unit formed from a base (7) or a base plate (7a), the arm (8) and a fastening shield (9), and can be secured in a visually concealed manner by a decorative sleeve.

The present invention relates to a ceiling- or wall-flush-mounted structural holder for temporary and permanent light fittings or luminaires, etc.

### BACKGROUND OF THE INVENTION-PROBLEM TO BE SOLVED

Light fittings which can be attached to the flat surface of a ceiling or wall have existed for many years. Said luminaires typically comprise a mounting plate which is mounted directly on the wall or the ceiling, a threaded fastening post or nipple which extends from the mounting plate, an enclosure or another decorative plate which can be mounted on the mounting plate by means of the mounting post, a threaded nut which is accommodated on the mounting post, and a light assembly which is connected to the canopy. The luminaire arrangement can comprise one or more light sockets and decorative arms, housings, casings, fastening chains and the like. The electric sockets are connected to an elongate electric cable which is connected to an electric power line arranged next to the mounting plate.

For example, patent publication US 2003/0193810 A1 describes a luminaire which comprises a junction box, an annular mounting plate, a cap, a collar loop, a union nut and a luminaire arrangement having an electric cord of a certain length. The cap comprises an outer shell and a central winding spool which is mounted concentrically within the outer case of the cap and concentrically about a mounting opening within the cap. The central winding spool has a generally cylindrical central portion and an annular flange portion which extends from the upper side of the central portion. The slack portion of the electric cord can be wound around the winding spool in order to stow said cord in a safe and efficient manner.

Furthermore, for example, patent publication US 2011/0048793 A1 describes a ceiling suspension arrangement for suspending an object with a cable, a cord or a string on a ceiling, comprising a ceiling fitting, a covering or a housing and a suspension device. The suspension device is adapted to be fastened to the ceiling, for example to a hook, ring or shackle. The suspension device and the ceiling fitting, the cover or the housing have interacting threads which make it possible for them to be screwed to one another and to thereby assume various vertical positions with respect to one another. The suspension device can comprise a projecting elongate portion which extends downward, has an axial channel for receiving the cable, a cord or string and an external thread. The ceiling fitting, the covering or the housing can comprise a portion having a through hole with an internal thread for interacting with the external thread of the projecting elongate portion in order to provide the ceiling fitting, the covering or the housing with a desired position, for example in close interaction with the ceiling. The ceiling covering, the housing or the fitting can be composed of two separate parts, of which one has a large opening on its lower side, into which a connecting plug can be introduced, and the other part can be divided along an axial plane.

During the finishing of the interior design of new buildings, simple lamp holders with connection wires, what are referred to as pendulum structures or structural holders, are clamped to the ceiling cable connection wires via two-pole luster terminals for future light fittings. Structural holders are generally also referred to in trade, for example in DIY stores, as a renovation holder or lamp holder or the like.

Illuminants are screwed into said pendulum structures or structural holders in order to carry out finishing work, such as wallpapering work and painting work, with suitable lighting, or in order to provide sufficient light for viewings or the first transitional period of the new resident.

Conventionally, after the interior work is finished, the pendulum structure or structural holders are removed again and it is left to the users to attach their lamps competently there.

The pendulum structures or structural holders used in this case have only a temporary strain relief device and may only carry individual illuminants. Such temporary measures are visually unattractive, conceal an increased risk of accident when overlong connection wires are present at the cable outlets and are not suitable for permanent use.

### OBJECT OF THE INVENTION

It is the object of the present invention to simplify the attaching of structural holders and/or to design same in such a manner that they do not conceal a risk of accident, have an attractive appearance, lie flush against a ceiling or wall, can be retained permanently as lamps and can be used, by means of a base unit, for the mounting of decorative lamps.

### SUMMARY OF THE SOLUTION ACCORDING TO THE INVENTION

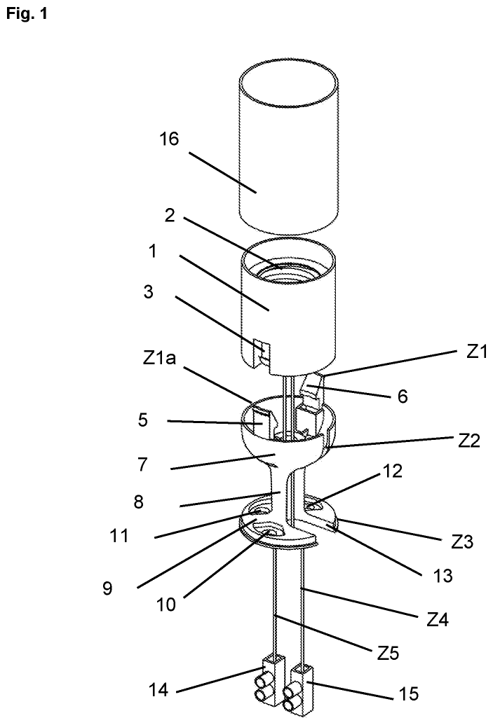

The present invention relates to a novel, waisted and modular structural holder, comprising a base (7) or a base plate (7a), which base or base plate is provided with cutouts and, in one embodiment, can be connected or is connected by latching hooks (5) and (6) to a holder (1), i.e. an illuminant holder (1), which, together with a decorative sleeve, for example 16 or 16a, produces the novel structural holder. The decorative sleeves can be of diverse design, for example as a cylinder, shown in FIG. 1, if desired can also be of conical design or alternatively can be in the form of a canopy (22). The structural holder according to the invention can be fastened at the beginning in a suspended manner with a strain relief device, like a conventional structural holder. Later, the structural holder, without the power connections having to be detached, can be fastened to a wall or ceiling because of the cutouts, the separate cables and the individual cable clamps provided according to the invention, for example clamping connectors or luster terminals, and all of the power lines can be looped, in particular tightly, around the arm (8) of a base unit (7-9), which forms a unit formed from a base (7) or a base plate (7a), the arm (8) and a fastening shield (9), and can be secured in a visually concealed manner by means of a decorative sleeve.

The object is achieved according to the invention in that a novel, waisted and modular structural holder comprising a base (7) or a base plate (7a) has been provided with cutouts and further details and has been connected to an illuminant holder, for example by latching hooks, which produce the novel structural holder by themselves or together with the decorative sleeve. The achievement according to the invention of the object is in particular also apparent in the drawings, FIG. 1 to FIG. 20, and from the claims and exemplary embodiments 1 to 5. The terms used here within the scope of the description of the invention are used in the meaning with which a person skilled in the art is familiar.

The invention relates here in particular to the structural holder which is indicated in the claims, is mounted flush with a ceiling or wall and serves for the temporary or permanent fastening of light fittings. The term “structural holder” used according to the invention also stands here for such terms or is synonymous with the terms which are conventional in trade, for example in DIY stores, for structural holders, for example renovation holder, lamp holder or the like. Structural holders or renovation holders, lamp holders or the like serve for receiving an (electric) illuminant. Illuminants are all electrical equipment and electrical consumers which serve to generate light, and also all objects which generate light by chemical or physical processes. Illuminants therefore form a light source. Such illuminants can be of diverse type, for example bulbs, neon tubes, LEDs and the like. The term illuminant as used in the present invention is more precise than the previously used term “lamps” by which both illuminants and sometimes also luminaires have previously been referred to, and the term illuminant therefore always refers only to the light-generating component(s) of luminaires. The term “light fitting”, as used within the scope of the present invention, is synonymous with the term “luminaire”, in particular, for example, in the permanently mounted state, and also comprises luminaires if the latter comprise, for example, a decorative sleeve or a canopy, and which are then referred to as “decorative luminaires”.

Said structural holder can be fastened at the beginning, in a suspended manner with a strain relief device, like a conventional structural holder, in order to be able to carry out residual work on a ceiling or wall. Within the scope of the invention, the term “strain relief device” refers to a mechanical protection device for flexible electric lines. Strain relief devices have to be present in portable electrical equipment, and the tensile strength—depending on the mass of the appliances—is prescribed in many countries by special safety regulations. Strain relief devices are often metal or plastics clips which protect flexible electric connection cables (stranded leads) from being torn out. The cables are clamped for this purpose. Cable screw connections can also have a strain relief function. In preferred embodiments according to the invention of the structural holder according to the invention, a strain relief device can therefore be provided or present. This applies even if such a strain relief device is not specifically mentioned in figures or descriptions of the figures. Within the context of the invention, the bores (10) to (12) provided in the fastening shield (9) described below can also serve as a strain relief device by the structural holder being suspended via one of said bores, for example directly in a hook attached in the ceiling or wall or optionally via a band or the like, or being fixed via a dowel introduced into the ceiling or wall by a screw connection, optionally also loose screw connection (i.e. only partially screwed in).

Later, the structural holder, without having to detach the power connections, can be fastened flush to the ceiling because of the cutouts around the cable sheath, and all of the power lines, because of the separate cables with, for example, individual cable clamps or luster terminals, are looped, in particular tightly, around the arm, are visually concealed, for example, by a decorative sleeve and are secured by being latched into place.

In one embodiment, said structural holder has holes on the base for a later screw connection to a wall or room ceiling or, in an alternative embodiment, it can also be fastened if desired to a surface via an adhesive surface without aids. The base can be interchanged at any time because of its cutouts, without the cable connections being released.

After a strain-relieving fastening, for example via a screw connection, the structural holder can be converted into a permanent luminaire. Alternatively, the final user of the rooms can upgrade the structural holder by means of decorative luminaire units.

### DESCRIPTION WITH REFERENCE TO THE DRAWING

The invention will be explained in more detail below with reference to the drawings, FIG. 1 to FIG. 8:

### FIG. 1

FIG. 1 shows an exploded drawing of the holder (1), also referred to as illuminant holder (1), with its thread (2) for the illuminants, and the latching opening (3), the opposite latching opening (4) not being visible, for the latching hooks (5) and (6) with their flexible excess lengths (Z1) and (Z1a). Furthermore, FIG. 1 shows a unit formed from a base (7), an arm (8) and a fastening shield (9). Within the context of this invention, the unit formed from the base (7), the arm (8) and the fastening shield (9) is also referred to as a “base unit (7-9)”.

The latching hooks (5) and (6) connect the base (7) to the illuminant holder (1), wherein the base unit (7-9), formed from the base (7) with its arm (8) for maintaining space from the fastening shield (9) with its bores (10) to (12), with the groove (Z3) and cutouts (13) and (Z2), then serve for fastening to a wall or room ceiling.

The individually fitted luster terminals (14) and (15) on the connection cables (Z4) and (Z5) serve for connection to power supplies present on site. The decorative sleeve (16) can be pushed over the structural holder according to the invention, even after the mounting. The decorative sleeve (16) is fixed here by the flexible excess lengths (Z1) and (Z1a) of the latching hooks (5) and (6) and/or by the groove (Z3) in the fastening shield (9).

Within the context of the invention, the term “flexible” or “flexible excess lengths” and the like means that the excess lengths beyond the latching hooks (5) and (6) are mounted resiliently.

The decorative sleeve (16) can be designed decoratively and provided with a protective film which is removed only after the painting work is finished. The decorative sleeves can be of diverse configuration, for example in the form of a cylinder, as shown in FIG. 1, if desired can also be of conical configuration or, alternatively, in the form of a canopy (22).

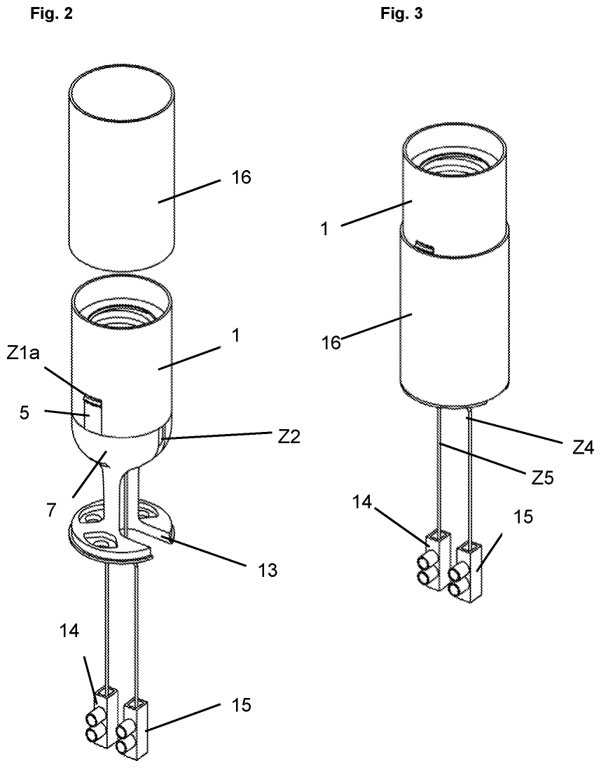

### FIG. 2

FIG. 2 shows the decorative sleeve (16), the illuminant holder (1) connected to the base (7), the luster terminals (14) and (15), the excess length (Z1a), the opposite excess length (Z1) not being visible, the visible part of the latching hooks (5) and the cutout (13) in the fastening shield (9) and the cutout (Z2) in the base (7). FIG. 2 therefore shows an illuminant holder (1) which is connected via the latching hooks (5) and (6), latching hooks (6) not being visible here, and via the latching openings (3) and (4), which are concealed after latching into place, to the base unit (7-9) which is formed from the base (7), the arm (8) and the fastening shield (9).

### FIG. 3

FIG. 3 shows the decorative sleeve (16) which is pushed over the base (not visible) and is located below the illuminant holder (1), and also the luster terminals (14) and (15) and the supply lines or connection cables (Z4) and (Z5). It is furthermore shown how the decorative sleeve (16) has been fixed by the groove (Z3) and by the flexible excess lengths (Z1) and (Z1a) of the latching hooks (5) and (6), as are in each case apparent in FIG. 1.

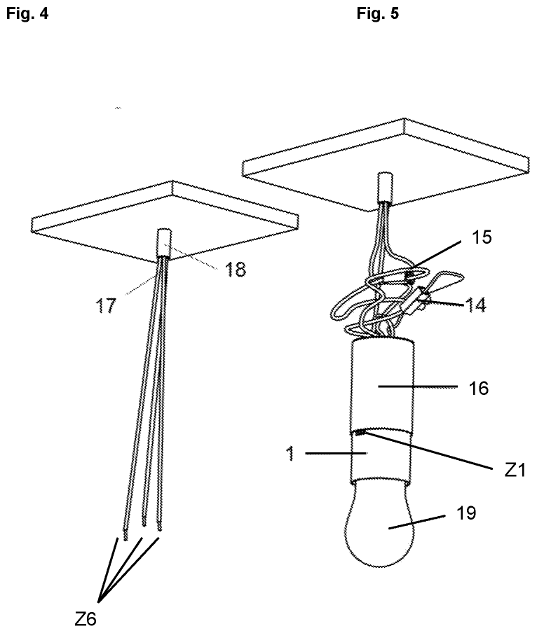

### FIG. 4

FIG. 4 shows the lamp cable which is led on site out of the wall or ceiling together with the electric connection wires (17), the cable sheath (18) and the stripped cable ends (Z6).

### FIG. 5

FIG. 5 shows by way of example the connection of the structural holder to the luster terminals (14) and (15) and a by means of said temporary fastening of the illuminant holder (1) and of the base (not visible) to that of the decorative sleeve (16) and the illuminant (19). The decorative sleeve (16) is protected here by the flexible excess lengths (Z1) and (Z1a), the excess length (Z1a) not being visible, against slipping down in the direction of the illuminant (19).

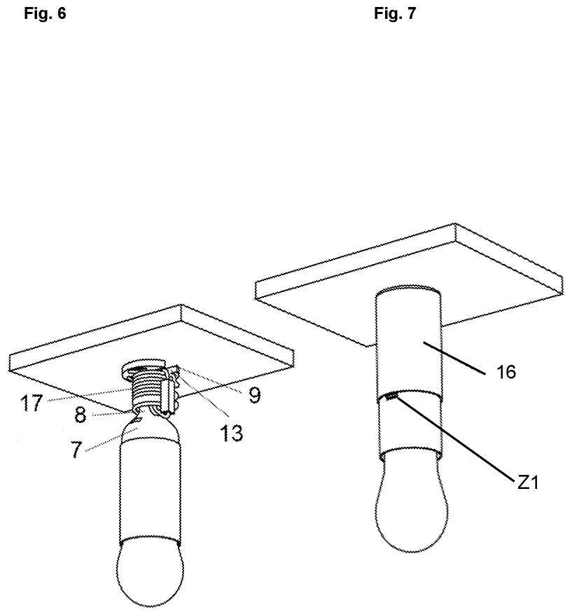

### FIG. 6

FIG. 6 demonstrates how the cutout (13) of a fastening shield (9) has been pushed over the to cable sheath (18), not visible here, of the lamp cable (also see (18) in FIG. 4) and has been screwed against the wall or ceiling and how connection wires (17) are looped tightly around the arm (8) on the base (7).

### FIG. 7

FIG. 7 shows how, furthermore, the decorative sleeve (16) conceals all of the connections when said decorative sleeve is pushed upward and the luminaire is ready for operation. The decorative sleeve (16) is also protected again here by the flexible excess lengths (Z1) and (Z1a) against slipping, with only the excess length (Z1) being visible here.

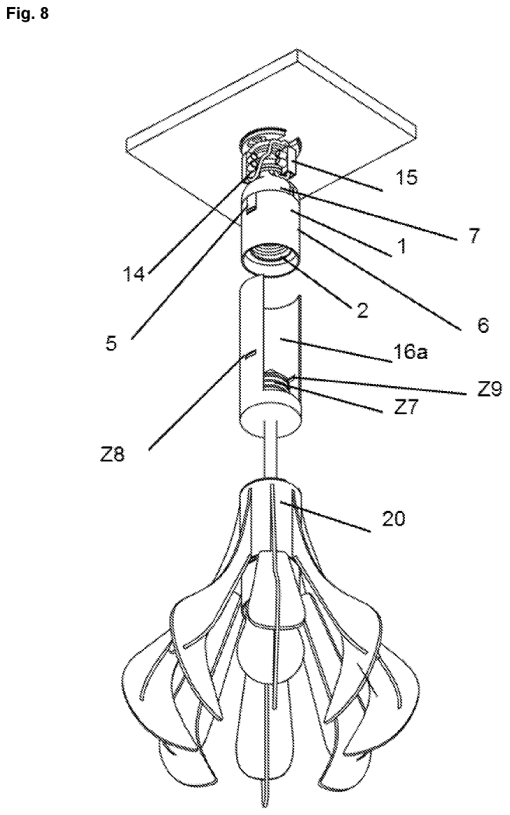

### FIG. 8

FIG. 8 demonstrates by way of example how a decorative luminaire (20), for example in the form of a living room lamp (20) or a pendant luminaire (20), with a decorative sleeve (16a) shaped as desired comprises the illuminant holder (1) and the base (7), which can also be designed as a base plate (7A), and the wound-up cables with the luster terminals (14) and (15). The threaded base (Z7) with the decorative sleeve (16a) is rotated here into the thread (2) provided for receiving the illuminant, in order to ensure the power supply for the luminaire (20), for example in the form of a living room lamp (20) or pendant luminaire (20), and how the decorative sleeve (16a) latches into the latching hook receptacles (Z8) and (Z9) by means of the latching hooks (5) and (6), latching hooks (6) not being visible. The latching hook receptacles (Z8) and (Z9) can also have the function here of a strain relief device.

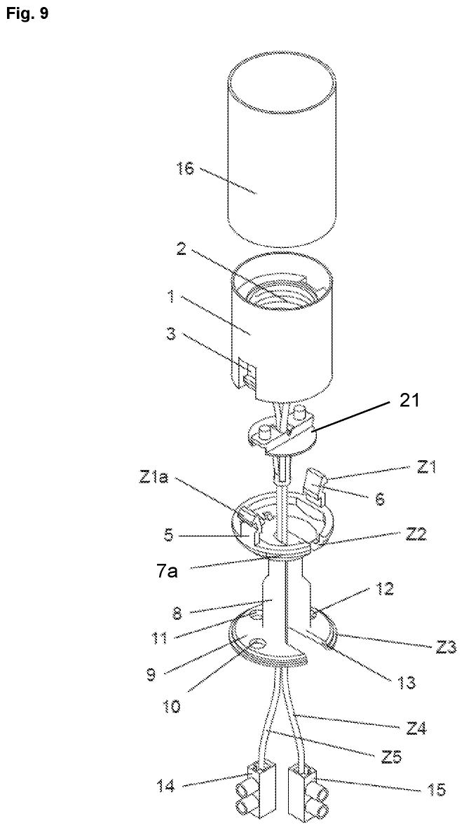

### FIG. 9

FIG. 9, like FIG. 1, shows an exploded drawing of the holder (1), also referred to as illuminant holder (1), with its thread (2) for the illuminants, and the latching opening (3), the opposite latching opening (4) not being visible, for the latching hooks (5) and (6) with their flexible excess lengths (Z1) and (Z1a). Furthermore, FIG. 9 shows a unit which is formed from a base (7), which is designed in the present case as a base plate (7a), an arm (8), which is waisted here, and a fastening shield (9). Within the context of this invention, the unit formed from the base (7), also designed as a base plate (7a), from the arm (8) and the fastening shield (9) is also referred to as a “base unit (7-9)”.

The term “waisted” means here that the arm (8) has a “waist”, and therefore an arm (8) is preferably present which, in the portion adjoining the base (7) or the base plate (7a) is tapered on the outside and/or on the inside in relation to the portion adjoining the fastening shield (9).

The latching hooks (5) and (6) connect the base plate (7a) to the illuminant holder (1), wherein the base unit (7-9), formed from the base plate (7a) with its arm (8) for maintaining distance in relation to the fastening shield (9) with its bores (10) to (12), together with the groove (Z3) and cutouts (13) and (Z2), serve for the fastening to a wall or room ceiling.

The individually fitted luster terminals (14) and (15) on the connection cables (Z4) and (Z5) serve for the attachment to power supplies present on site. The decorative sleeve (16) can be pushed over the structural holder according to the invention, even after the mounting. The decorative sleeve (16) is fixed here by the flexible excess lengths (Z1) and (Z1a) of the latching hooks (5) and (6) and/or by the groove (Z3) in the fastening shield (9).

The decorative sleeve (16) can be designed decoratively and provided with a protective film which is removed only after the painting work is finished.

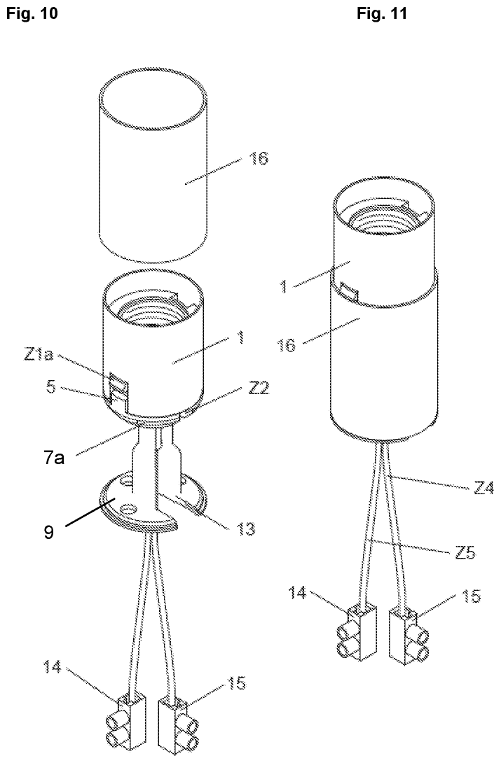

### FIG. 10

FIG. 10, like in FIG. 2, shows the decorative sleeve (16), the illuminant holder (1) which is connected to the base (7), which is designed in the present case as a base plate (7a), the luster terminals (14) and (15), the excess length (Z1a), the opposite excess length (Z1) not being visible, the visible part of the latching hooks (5) and the cutout (13) in the fastening shield (9) and the cutout (Z2) in the base plate (7a). FIG. 2 therefore shows an illuminant holder (1) which is connected via the latching hooks (5) and (6), latching hooks (6) not being visible here, and via the latching openings (3) and (4), which are no longer visible after latching into place, to the base unit (7-9) which is formed from the base plate (7a), the arm (8) and the fastening shield (9).

### FIG. 11

FIG. 11, like FIG. 3, shows the decorative sleeve (16) which is pushed over the base (not visible) and is located below the illuminant holder (1), and also the luster terminals (14) and (15) and the supply lines or connection cables (Z4) and (Z5). It furthermore shows how the decorative sleeve (16) has been fixed by the groove (Z3) and by the flexible excess lengths (Z1) and (Z1a) of the latching hooks (5) and (6), as are each apparent in FIG. 1 or FIG. 9.

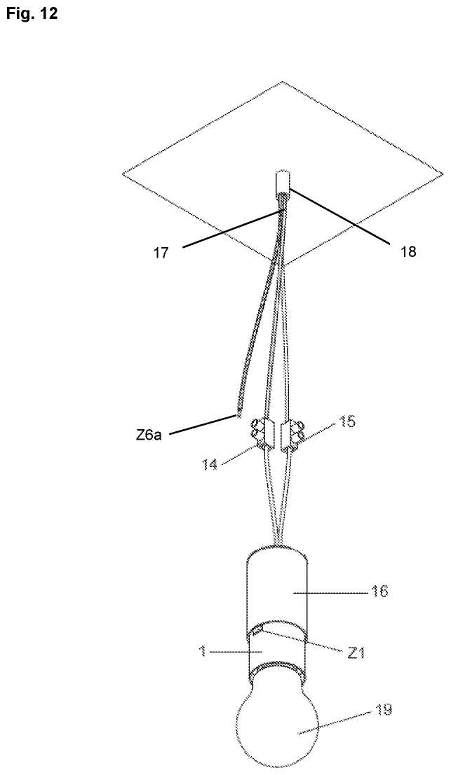

### FIG. 12

FIG. 12 shows, like in FIG. 4, the lamp cable which is led on site out of the wall or ceiling together with the electric connection wires (17), the cable sheath (18) and the stripped cable ends (Z7), wherein (Z6a) illustrates the stripped cable end of the ground line (E) of the connection wires (17), and wherein furthermore, as in FIG. 5, by way of example the connection of the structural holder to the luster terminals (14) and (15) and a by means of said temporary fastening of the illuminant holder (1) and of the base (designed here as a base plate (7a) which is not visible) to that of the decorative sleeve (16) and the illuminant (19) is shown. The decorative sleeve (16) is protected here by the flexible excess lengths (Z1) and (Z1a), the excess length (Z1a) not being visible, against slipping down in the direction of the illuminant (19).

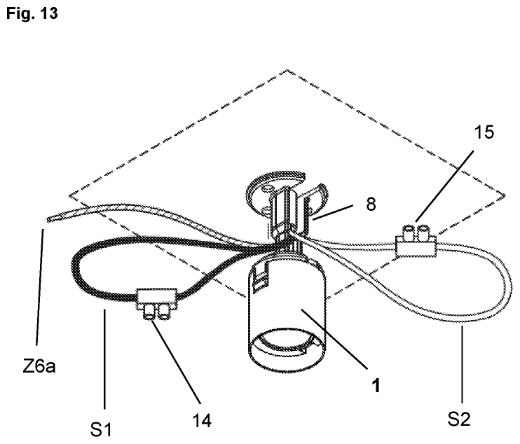

### FIG. 13

FIG. 13 demonstrates how the electric connection wires (17), via the stripped cable ends (Z7), no longer visible here, by way of example undertakes the connection of the structural holder with the luster terminals (14) and (15) to the supply lines or connection cables (Z4) and (Z5) of the illuminant holder (1) with the formation of loops, wherein the stripped cable end (Z6a) of the ground line (E) of the connection wires (17) remains free. The loops or cable loops (S1) and (S2) can subsequently be looped around the arm (8) of the base unit (7-9). The black loops or cable loops (S1) constitute the conductor (L) here and the white loop or cable loop (S2) constitutes the conductor (N) here.

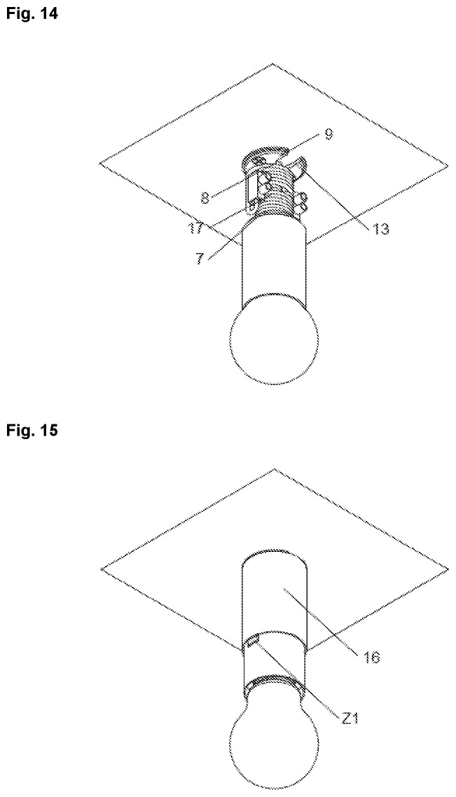

### FIG. 14

FIG. 14 demonstrates how the cutout (13) of a fastening shield (9) has been pushed over the cable sheath (18), no longer visible here, and has been screwed against the wall or ceiling and how connection wires (17) have been looped tightly around the arm (8) on the base (7), said base being designed here as a base plate (7a).

### FIG. 15

FIG. 15 then shows how, furthermore, the decorative sleeve (16) conceals all of the connections from FIG. 14 when said decorative sleeve is pushed upward and the luminaire is ready for operation. The decorative sleeve (16) is also protected here again via the flexible excess lengths (Z1) and (Z1a) against slipping, with only the excess length (Z1) being visible here.

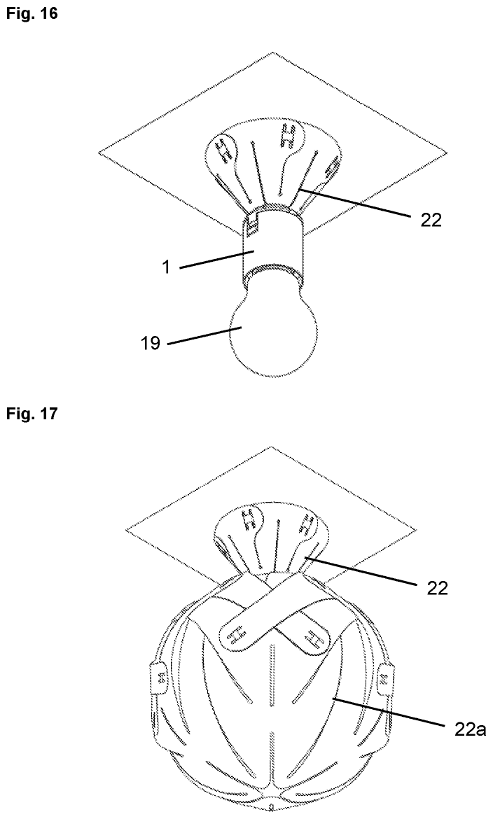

### FIG. 16

FIG. 16 shows an alternative to the decorative sleeve (16) all of the connections from FIG. 14 and FIG. 15, said alternative being designed as a canopy (22) (lamp canopy, for example of a button loop lamp, for example as is described in German patent application DE 10 2017 130863.6 with the filing date of Dec. 21, 2017, and also in the registered EU-registered design EU 004541969-001-0014 (registration date Dec. 11, 2017)), and wherein the canopy (22) here in FIG. 16 conceals all of the connections from FIG. 14 when the canopy (22) fixed between ceiling or wall (or optionally alternatively the optionally additional ceiling covering or wall covering (23) with the larger covering surface than the fastening shield (9); what is referred to as a “hide”), on the one hand, and the base plate (7a), on the other hand, and the luminaire is ready for operation and is protected against slipping.

### FIG. 17

FIG. 17 then shows by way of example how the structural holder of FIG. 16 with the canopy (22) is provided with a decorative lampshade (22a), for example a button loop lamp, for example as is described in German patent application DE 10 2017 130863.6 with the filing date of Dec. 21, 2017, and also in the registered EU-registered design EU 004541969-001-0014 (registration date Dec. 11, 2017).

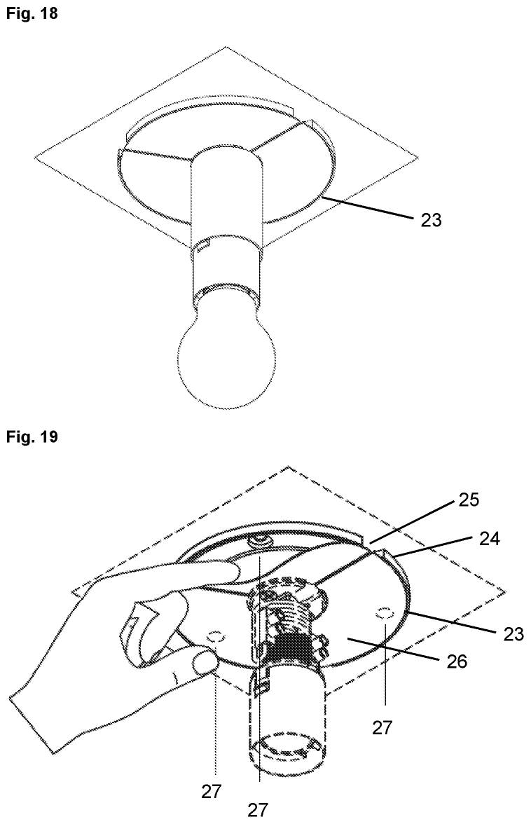

### FIG. 18

FIG. 18 demonstrates by way of example a ceiling- or wall-mounted kit consisting of a structural holder according to the invention, wherein, in addition to the structural holder or to the base unit, the mounted kit comprises an additional ceiling covering or wall covering (23), wherein the additional ceiling covering or wall covering (23) is mounted flush with a ceiling or wall, and wherein the additional ceiling covering or wall covering (23) has a larger covering surface than the fastening shield (9) which is no longer visible here.

According to the invention, the additional ceiling covering or wall covering (23) is used if not only the cable sheath (18) projects out of the ceiling or wall, but also if the ceiling or wall has a larger opening around the cable sheath (18), which opening cannot be covered or concealed and/or screw-connected by means of a structural holder according to the invention by itself.

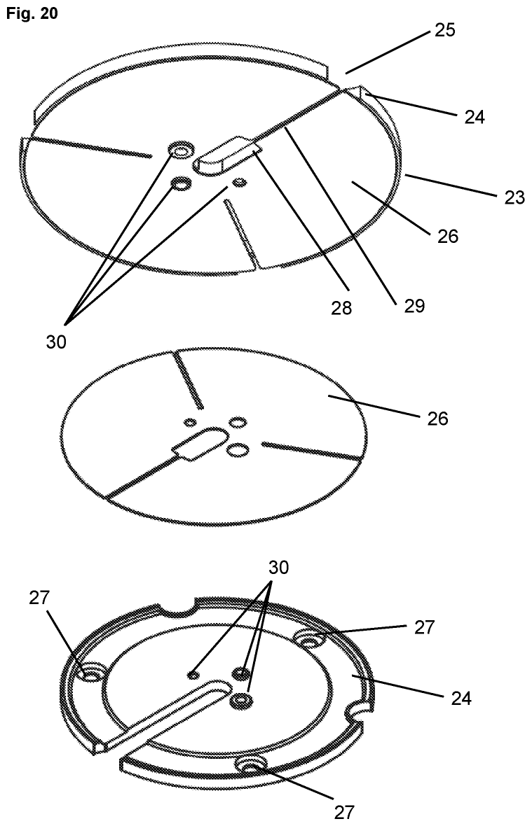

### FIGS. 19 and 20

FIGS. 19 and 20 demonstrate by way of example the construction of an optionally additional ceiling covering or wall covering (23) with a covering surface (what is referred to as a “hide”) which is larger than the fastening shield (9) and is intended for attaching to the ceiling or wall and for the fastening of the structural holder according to the invention to the base (7) or the base plate (7a) via the fastening shield. FIG. 19 shows here the flexible properties of the covering plate (26) of the ceiling covering or wall covering (23).

The ceiling covering or wall covering (23) has a ceiling plate or wall plate (24) for attaching to the ceiling or wall and for the fastening of the structural holder according to the invention to the base (7) or to the base plate (7a) via the fastening shield, and a flexible covering plate (26), in particular for plugging onto the ceiling plate or wall plate (24). Furthermore, the ceiling plate or wall plate (24) of the additional ceiling covering or wall covering (23) has a cutout (25), and there are bores (27) in the ceiling plate or wall plate (24) for the ceiling fastening or wall fastening of the ceiling plate or wall plate (24).

The flexible covering plate (26) has a central cutout and a slot (28) in the covering plate (26), wherein the slot (28) extends from the edge of the covering plate (26) to the central cutout (28) in the covering plate (26).

Furthermore, there are bores (30) in the ceiling plate or wall plate (24) and in the covering plate (26), preferably with different diameters, which serve for the fastening of the fastening shield (9) to the additional ceiling covering or wall covering (23), for example by means of screws and lock nuts.

### DETAILED DESCRIPTION OF THE SOLUTION ACCORDING TO THE INVENTION

The invention relates to a structural holder which is mounted flush with a ceiling or wall and serves for the temporary or permanent fastening of light fittings, comprising:
an illuminant holder (1),
at least two supply lines (Z4, Z5) which can be attached or are attached to the illuminant holder (1) and wherein individual cable clamps (14, 15) can be attached or are attached to each end of the at least two supply lines (Z4, Z5),
a base unit (7-9) which can be connected or is connected to the illuminant holder (1) by being plugged thereon,
   wherein the base unit (7-9) is configured in such a manner that at least two connection wires (17) present on site, after said connection wires (17) are attached to the at least two supply lines (Z4, Z5) via the individual cable clamps (14, 15), can be looped, in particular tightly, around the base unit (7-9), preferably around a part of the base unit (7-9) that is tapered in relation to the external dimensions.

In one embodiment, the invention can also relate to a structural holder which is mounted flush with a ceiling or wall and serves for the temporary or permanent fastening of light fittings, comprising:
an illuminant holder (1),
at least two supply lines (Z4, Z5) which can be attached or are attached to the illuminant holder (1) and wherein individual cable clamps (14, 15) can be attached or are attached to each end of the at least two supply lines (Z4, Z5),
a base unit (7-9) which can be connected or is connected to the illuminant holder (1) by being plugged thereon,
   wherein the base unit (7-9) is configured in such a manner that at least two connection wires (17) present on site, after said connection wires (17) are attached to the at least two supply lines (Z4, Z5) via the individual cable clamps (14, 15) can be looped so tightly around part of the base unit (7-9) that the interconnected at least two connection wires (17), at least two supply lines (Z4, Z5) and individual cable clamps (14, 15) lie completely within the outer circumference of the base unit (7-9).

The term “looped”, or “looped around”, “loop” and the like means that there is no winding in the actual sense, that is to say no winding with properties of a spool, but rather, as demonstrated for example in FIG. 13, the base unit (7-9) is looped around by the electric connection wires (17) which, via stripped cable ends (Z7), bring about the connection of the structural holder with the luster terminals (14) and (15) to the supply lines or connection cables (Z4) and (Z5) of the illuminant holder (1) with loops being formed, wherein the stripped cable end (Z6a) of the ground line (E) of the connection wires (17) remains free. The loops and the ground line can subsequently be looped individually around the arm (8) of the base unit (7-9), and therefore looping around arises without properties of a spool. According to the invention, it is therefore of importance that the connection wires (17) are encased individually, i.e. no longer by the cable sheath (18), with the exception of the first two centimeters emerging from the ceiling or wall. The cable sheath (18) therefore preferably has a length of approximately up to a maximum of two centimeters, and the individual connection wires (17) have a length of approximately up to a maximum of 20 centimeters.

The invention therefore relates to a structural holder which, for example after mounting, is mounted flush with a ceiling or wall and serves for the temporary or permanent fastening of light fittings, comprising a base unit (7-9) connected to an illuminant holder (1) and on-site connection wires (17) which are attached to supply lines (Z4, Z5) for the illuminant holder (1) by means of individual cable clamps (14, 15), wherein the connection wires (17) are looped, in particular tightly, around the base unit (7-9).

The term “cable clamp” is synonymous with the term “cable connector” and, within the scope of the invention, refers to a fastening means for the, in particular secure and fixing, attachment of an electric connection cable or supply line, i.e., for example, via stripped cables ends (Z6) of the connection wires (17), to power supplies present on site. The connection can be implemented here, for example, in particular by means of clamping connections, plug-in connections, clamping and plug-in connections, screw and clamping connections, and plug-in screw connections. Suitable cable clamps are known to a person skilled in the art, such as, for example, cable connectors and/or luster terminals.

Connection wires, that is to say, within the scope of the present invention, electric connection wires, serve for applying power to the illuminant, i.e. are electric lines. Electric lines consist of metallic electric conductors, generally in the form of wires or strands, in particular, for example, made of copper or aluminum, and also the insulating encasing thereof. If a plurality of conductors (wires) which are insulated from one another are combined, they are referred to as a line. The individual wires are called, for example neutral line, outer line and grounding line. Conventionally, the connection wires are therefore the individual insulator-encased cable cores of an electric cable. In electrical engineering, a single- or multi-wired assembly of wires (individual lines) which are sheathed by insulating materials and serves for transmitting energy (power) is generally referred to as a cable. The insulating materials used are conventionally different plastics which surround the wires used as conductors and insulate them from one another. The number of power-conducting conductors, also called wires, in the cable is the number of conductors or number of wires.

In the case of multi-wired cables, each individual wire is always encased by a dedicated insulator, the wire insulation, while an outer encasing, the cable sheath, surrounds all of the wires.

Within the context of the invention, at least in each case two supply lines (Z4, Z5) are provided for the attachment to at least two electric connection wires (17) present on site. Within the scope of the invention, it can also be provided for there to be three supply lines (Z4, Z5, E) for the attachment to three electric connection wires (17) present on site, in the event that the electric connection wires (17) provided on site also comprise a grounding line (E), which is also referred to as a ground line. The ground line or the ground connection conventionally serves as an electrical protective measure in the presence of electrically conductive housing parts and parts which can be touched and in electric devices with hazardous voltages, for example by the electrically conducting housing parts and touchable parts of such electrical devices being connected to one another and to the ground by protective conductors (the protective conductor network of the electrical installation or a ground connection). If the housing parts and touchable parts of the electrical device are made of plastic, the ground line or the grounding line (E) can be omitted, and therefore it can then be provided within the context of the invention that there are only two supply lines (Z4, Z5) for the attachment to two electric connection wires (17) present on site, and wherein the ground line or grounding line (E) then remains free, i.e. is not attached to the structural holder. The structural holder according to the invention can be configured in such a manner that it can receive two to up to five connection wires, for example of a two to five-wire cable.

Within the scope of the invention, the term “base unit (7-9)” refers to a unit formed from a base (7), an arm (8) and a fastening shield (9). The fastening shield (9) serves here in particular as a wall holder or ceiling holder, or, as already described, can also serve as a strain relief device.

The invention also relates to a base unit for a structural holder which is mounted flush with a ceiling or wall and serves for the temporary or permanent fastening of light fittings, wherein the structural holder comprises an illuminant holder (1) and at least two supply lines (Z4, Z5) which can be attached or are attached to the illuminant holder (1), and wherein individual cable clamps (14, 15) can be attached or are attached to each end of the at least two supply lines (Z4, Z5),
wherein the base unit is a base unit (7-9) formed from a base (7), an arm (8) and a fastening shield (9),
wherein the base unit is configured for connecting to an illuminant holder (1) by plugging same onto the base unit (7-9), and
wherein the base unit (7-9) is configured in such a manner that at least two connection wires (17) present on site after by the illuminant holder (1) being plugged onto the base unit (7-9), after said connection wires (17) are attached to the at least two supply lines (Z4, Z5) via the individual cable clamps (14, 15), can be looped tightly around the base unit (7-9), preferably around a part of the base unit (7-9) that is tapered in relation to the external dimensions.

In a preferred embodiment, it can be provided that the structural holder according to the invention or the base unit according to the invention is characterized in that the base unit (7-9) has a cutout (Z2) in the base (7) and a cutout (13) in the fastening shield (9).

In a preferred embodiment, it can be provided that the structural holder according to the invention or the base unit according to the invention is characterized in that the base unit (7-9) has a cutout (Z2a) in the arm (8), preferably wherein said cutout corresponds to the cutout (Z2) in the base (7) and to the cutout (13) in the fastening shield (9), furthermore preferably wherein the cutout (Z2a) in the arm (8) forms an interior space in the arm (8), said interior space being open toward the cutout (Z2a), particularly preferably wherein said open interior space in the arm (8) is also open toward the base (7) and toward the fastening shield (9).

In a preferred embodiment, it can be provided that the structural holder according to the invention or 3 to 4 or the according to the invention is characterized in that the base (7) in the base unit (7-9) is designed as a base plate (7a).

In a preferred embodiment, it can be provided that the structural holder according to the invention or the base unit according to the invention is characterized in that the base unit (7-9) has an arm (8) which, in the portion adjoining the base (7) or the base plate (7a), is tapered on the outside and/or on the inside in relation to the portion adjoining the fastening shield (9).

In a preferred embodiment, it can be provided that the structural holder according to the invention or the base unit according to the invention is characterized in that, on the base (7) or the base plate (7a), the base unit (7-9) has flexible latching hooks (5, 6) with excess lengths (Z1, Z1a), preferably wherein the excess lengths (Z1, Z1a) on the flexible latching hooks (5, 6) are beveled on the upper side to one of the two sides, and/or in that the base unit (7-9) has a groove (Z3) on the fastening shield (9).

The structural holder as claimed in one of claims 1 or 3 to 7 or the base unit as claimed in one of claims 2 to 7, characterized in that the base unit (7-9) forms a unit formed from a base (7) or base plate (7a), an arm (8) and a fastening shield (9), preferably wherein the fastening shield (9) serves as a wall holder or ceiling holder, furthermore preferably wherein the fastening shield (9) has bores (10-12) for the ceiling or wall fastening.

A structural holder of the invention can be characterized in that the base unit (7-9) forms a unit formed from a base (7), an arm (8) and a fastening shield (9), preferably wherein the fastening shield (9) serves as a wall holder or ceiling holder, furthermore preferably wherein the fastening shield (9) has bores (10-12) for the ceiling or wall fastening.

The structural holder of the invention can preferably be characterized in that the base unit (7-9) has a cutout (Z2) in the base (7) and a cutout (13) in the fastening shield (9).

In a preferred embodiment, it can be provided that the structural holder according to the invention or the base unit according to the invention is characterized in that a decorative sleeve (16) or a canopy (22) can be plugged or is plugged over the base unit (7-9) and connections of the structural holder in such a manner that, by means of the decorative sleeve (16), the connections, which are formed by the connection wires (17), the cable clamps (14, 15) and the supply lines (Z4, Z5), can be concealed or are concealed by the decorative sleeve (16) or the canopy (22).

In one refinement, the structural holder according to the invention relates to a decorative sleeve (16) is plugged over the structural holder and over connections which are formed by the connection wires (17), the cable clamps (14, 15) and the supply lines (Z4, Z5), and conceals same. Said structural holder of the invention is characterized in that a decorative sleeve (16) can be plugged or is plugged over the base unit (7-9) and connections of the structural holder in such a manner that, by means of the decorative sleeve (16), the connections, which are formed by the connection wires (17), the cable clamps (14, 15) and the supply lines (Z4, Z5), can be concealed or are concealed by the decorative sleeve (16).

In a preferred embodiment, it can be provided that the structural holder according to the invention or the base unit according to the invention is characterized in that the illuminant holder (1) can be connected or is connected via the base unit (7-9) to a fastening shield (9) which preferably serves as a wall holder or ceiling holder (9), wherein preferably the illuminant holder (1) can be latched or is latched into the base unit (7-9), furthermore preferably into the base (7) or base plate (7a) of the base unit (7-9).

In a further refinement, the structural holder according to the invention is distinguished in that the illuminant holder (1) is connected to a wall holder or ceiling holder (9) into which said illuminant holder can be latched. Said structural holder of the invention is characterized in that the illuminant holder (1) can be connected or is connected via the base unit (7-9) to a fastening shield (9) which preferably serves as a wall holder or ceiling holder (9), wherein preferably the illuminant holder (1) can be latched or is latched into the base unit (7-9), furthermore preferably into the base (7) of the base unit (7-9).

The invention preferably relates to a structural holder as described above which is characterized in that the base unit (7-9) has flexible latching hooks (5, 6) on the base (7), preferably wherein the flexible latching hooks (5, 6) have excess lengths (Z1, Z1a), and/or in that the base unit (7-9) has a groove (Z3) on the fastening shield (9).

In a preferred embodiment, it can be provided that the structural holder according to the invention or the base unit according to the invention characterized in that the base unit (7-9) of said structural holder consists of a base (7) or base plate (7a), arms (8) and a fastening shield (9), wherein the base (7) or base plate (7a) has a cutout (Z2) and flexible latching hooks (5, 6) for connecting to latching openings (3, 4) of the illuminant holder (1), and/or the fastening shield (9) has bores (10-12) for the ceiling fastening or wall fastening, and a cutout (13).

Furthermore, the invention preferably relates to a structural holder which is characterized in that the base unit (7-9) of said structural holder consists of a base (7), arms (8) and a fastening shield (9), wherein the base (7) has a cutout (Z2) and latching hooks (5, 6) for connecting to latching openings (3, 4) of the illuminant holder (1), and the fastening shield (9) has bores (10-12) for the ceiling fastening or wall fastening, and a cutout (13).

In a preferred embodiment, it can be provided that the structural holder according to the invention (as indicated, for example, in claim 7 or 11) is characterized in that the flexible latching hooks (5, 6) have excess lengths (Z1, Z1a) and/or the fastening shield (9) has a groove (Z3), which excess lengths and/or groove in each case individually or jointly fix the decorative sleeve (16), or, in the case of a canopy (22) (lamp canopy, for example of a button loop lamp, for example as is described in German patent application DE 10 2017 130863.6 with the filing date of Dec. 21, 2017 and also in the registered EU-registered design EU 004541969-001-0014 (date of registration Dec. 11, 2017)), the canopy (22) is fixed between the ceiling or wall (or optionally alternatively the optionally additional ceiling covering or wall covering (23) having a larger covering surface than the fastening shield (9); what is referred to as a hide), on the one hand, and the base plate (7a), on the other hand, and is protected against slipping.

Furthermore, the invention preferably relates to a structural holder which is characterized in that the latching hooks (5, 6) have excess lengths (Z1, Z1a) and the fastening shield (9) has a groove (Z3), which excess lengths and groove fix the decorative sleeve (16).

The described structural holder according to the invention or the described base unit according to the invention can preferably be characterized in that a defined distance is maintained between the ceiling or wall and that end of the structural holder or of the illuminant that is remote therefrom.

The described structural holder according to the invention or 3 to 13 or the described base unit according to the invention with an illuminant holder (1) can be characterized in that a threaded base with a decorative sleeve (Z7, 16a) as a connection for decorative luminaires can be screwed into said structural holder.

The above-described structural holder according to the invention can preferably be furthermore characterized in that a threaded base with a decorative sleeve (Z7, 16a) as a connection for decorative luminaires can be screwed into said structural holder.

The invention also relates to a kit consisting of a structural holder described according to the invention or a base unit described according to the invention, which is characterized in that, in addition to the structural holder or to the base unit, the kit comprises an additional ceiling covering or wall covering (23, “hide”), wherein the additional ceiling covering or wall covering (23) is mounted flush with a ceiling or wall, and wherein the additional ceiling covering or wall covering (23) has a covering surface which is larger than the fastening shield (9).

An exemplary construction of an optionally additional ceiling covering or wall covering (23) with a covering surface (what is referred to as a hide) which is larger than the fastening shield (9) and is intended for attaching to the ceiling or wall and for the fastening of the structural holder according to the invention to the base (7) or to the base plate (7a) via the fastening shield is described in FIG. 18 and FIG. 19, with the flexible properties of the covering plate (26) being shown in FIG. 19.

In one embodiment, the ceiling covering or wall covering (23) has a ceiling plate or wall plate (24) for attaching to the ceiling or wall and for the fastening of the structural holder according to the invention to the base (7) or the base plate (7a) via the fastening shield, and a flexible covering plate (26), in particular for plugging onto the ceiling plate or wall plate (24). Furthermore, in one embodiment, the ceiling plate or wall plate (24) of the additional ceiling covering or wall covering (23) has a cutout (25), and there are bores (27) in the ceiling plate or wall plate (24) for the ceiling fastening or wall fastening of the ceiling plate or wall plate (24).

In one embodiment, the flexible covering plate (26) has a central cutout and a slot (28) in the covering plate (26), wherein the slot (28) extends from the edge of the covering plate (26) to the central cutout (28) in the covering plate (26). The ceiling covering or wall covering (23) can therefore also be pushed retrospectively over a structural holder.

Furthermore, in one embodiment, there are bores (30) in the ceiling plate or wall plate (24) and optionally in the covering plate (26), preferably with different diameters, which bores serve for the fastening of the fastening shield (9) to the additional ceiling covering or wall covering (23), for example by means of screws and lock nuts. If there are bores (30) in the ceiling plate or wall plate (24) and optionally in the covering plate (26) with different diameters, as shown in FIGS. 19 and 20, said bores can serve virtually as a template for the correct fastening the of the fastening shield (9).

The invention finally also relates to an illuminant holder for a structural holder of the present invention which is mounted flush with a ceiling or wall and serves for the temporary or permanent fastening of light fittings, or for a kit of the present invention, wherein the structural holder comprises a base unit (7-9), and wherein the illuminant holder is configured for connecting by the illuminant holder (1) being plugged onto a base unit (7-9) which is configured in such a manner that at least two connection wires (17) present on site after the by the illuminant holder (1) being plugged onto the base unit (7-9), after said connection wires (17) are attached to the at least two supply lines (Z4, Z5) via the individual cable clamps (14, 15), can be looped, in particular tightly, around the base unit (7-9), preferably around a part of the base unit (7-9) that is tapered in relation to the external dimensions.

### EXEMPLARY EMBODIMENTS:

The exemplary embodiments below should be read with the relevant expert understanding with the assistance of the drawings.

1st embodiment: A ceiling-flush-mounted structural holder for temporary and permanent light fittings, characterized in that the connection wires are electrically connected to individual clamping connectors and said connection wires are looped tightly around the base (base unit 7-9) of the holder (structural holder).

2nd embodiment: The ceiling-flush-mounted structural holder for temporary and permanent light fittings as per the first embodiment, characterized in that a decorative sleeve is plugged over the holder and connections and conceals same.

3rd embodiment: The ceiling-flush-mounted structural holder for temporary and permanent light fittings as per the first embodiment, characterized in that the holder is connected to a wall holder or ceiling holder into which the holder can be latched.

4th embodiment: The ceiling-flush-mounted structural holder for temporary and permanent light fittings as per the 1st and 3rd embodiments, characterized in that a defined distance is maintained between the ceiling or wall and that end of the structural holder or of the illuminant that is remote therefrom.

5th embodiment: The ceiling-flush-mounted structural holder for temporary and permanent light fittings as per the 1st embodiment, characterized in that a threaded base with a decorative sleeve can be screwed in as a connection for decorative luminaires.

### LIST OF REFERENCE SIGNS:

No. Designation

1 Illuminant holder

2 Thread for receiving illuminants

3, 4 Latching openings (4 not visible)

5, 6 Latching hooks

7, 7a Base (7), optionally designed as a base plate (7a)

8 Arm for maintaining a distance between the base (7) and the fastening shield (9)

9 Fastening shield on the arm (8) of the base (7) or of the base plate (7a)

7-9 Base unit, unit formed from the base (7), arm (8) and fastening shield (9)

10, 11, 12 Bores in the fastening shield (9)

13 Cutout in the fastening shield (9)

14, 15 Cable clamps, for example cable connectors, for example luster terminals

16, 16a Decorative sleeve, 16a decorative sleeve with threaded base

17 Connection wires (of the lamp cable)

18 Cable sheath (of the lamp cable)

19 Illuminants, for example bulbs, etc.; alternatively optionally also in the form of a “lamp”

20 Living room lamp, optionally also designed as a pendant luminaire

21 Strain relief device (relief of supply lines, for example Z4 and Z5)

22 Canopy (lamp canopy, for example of a button loop lamp)

22a Decorative lampshade (22a), for example of a button loop lamp

23 Optionally additional ceiling covering or wall covering with a larger covering surface (what is referred to as a “hide”) than the fastening shield (9) which is intended for attaching to the ceiling or wall and for the fastening of the structural holder according to the invention to the base (7) or the base plate (7a) via the fastening shield

24 Ceiling plate or wall plate of the additional ceiling covering or wall covering (23) for attaching to the ceiling or wall and for the fastening of the structural holder according to the invention to the base (7) or the base plate (7a) via the fastening shield

25 Cutout in the ceiling plate or wall plate (24) of the additional ceiling covering or wall covering (23)

26 Flexible covering plate of the additional ceiling covering or wall covering (23), in particular for plugging onto the ceiling plate or wall plate (24)

27 Bores in the ceiling plate or wall plate (24) for the ceiling fastening or wall fastening of the ceiling plate (24)

28 Central cutout in the covering plate (26)

29 Slot in the covering plate (26), from the edge of the covering plate (26) to the central cutout (28) in the covering plate (26)

30 Bores in the ceiling plate or wall plate (24) and in the covering plate (26), preferably with different diameters, which serve for the fastening of the fastening shield (9) to the additional ceiling covering or wall covering (23), for example by means of screws and lock nuts

E Grounding line

S1, S2 Loops or cable loops

Z1, Z1a (Flexible) excess lengths at the latching hooks 5, 6 (serving for the fixing)

Z2 Cutout in the base (7)

Z2a Cutout in the arm (8)

Z3 Groove in the fastening shield (9) (serving for the fixing)

Z4, Z5 Connection cables or supply lines (for the attachment to power supplies present on site)

Z6 Stripped cable ends of the connection wires (17)

Z6a Stripped cable end of the ground line (E) of the connection wires (17)

Z7 Threaded base

Z8, Z9 Latching hook receptacles

1-16. (canceled)

17. A structural holder which is mounted flush with a ceiling or wall and serves for the temporary or permanent fastening of light fittings, comprising:
an illuminant holder,
at least two supply lines which can be attached or are attached to the illuminant holder and wherein individual cable clamps can be attached or are attached to each end of the at least two supply lines,
a base unit which can be connected or is connected to the illuminant holder by being plugged thereon,
wherein the base unit is configured in such a manner that at least two connection wires present on site, after said connection wires are attached to the at least two supply lines via the individual cable clamps, can be looped, in particular tightly, around the base unit, preferably around a part of the base unit that is tapered in relation to the external dimensions.

18. A base unit for a structural holder which is mounted flush with a ceiling or wall and serves for the temporary or permanent fastening of light fittings, wherein the structural holder comprises an illuminant holder and at least two supply lines which can be attached or are attached to the illuminant holder, and wherein individual cable clamps can be attached or are attached to each end of the at least two supply lines,
wherein the base unit is a base unit formed from a base, an arm and a fastening shield,
wherein the base unit is configured for connecting to an illuminant holder by plugging same onto the base unit, and
wherein the base unit is configured in such a manner that at least two connection wires present on site after by the illuminant holder being plugged onto the base unit, after said connection wires are attached to the at least two supply lines via the individual cable clamps, can be looped tightly around the base unit, preferably around a part of the base unit that is tapered in relation to the external dimensions.

19. The structural holder as claimed in claim 17, wherein the base unit has a cutout in the base and a cutout in the fastening shield.

20. The structural holder as claimed in claim 17, wherein the base unit has a cutout in the arm, preferably wherein said cutout corresponds to the cutout in the base and to the cutout in the fastening shield, furthermore preferably wherein the cutout in the arm forms an interior space in the arm, said interior space being open toward the cutout, particularly preferably wherein said open interior space in the arm is also open toward the base and toward the fastening shield.

21. The structural holder as claimed in claim 17, wherein the base in the base unit is designed as a base plate.

22. The structural holder as claimed in claim 17, wherein the base unit has an arm which, in the portion facing the base or the base plate, is tapered on the outer side in relation to the portion facing the fastening shield.

23. The structural holder as claimed in claim 17, wherein, on the base or the base plate, the base unit has flexible latching hooks with excess length, preferably wherein the excess lengths on the flexible latching hooks are beveled on the upper side to one or both sides, and/or in that the base unit has a groove on the fastening shield.

24. The structural holder as claimed in claim 17, wherein the base unit forms a unit formed from a base or base plate, an arm and a fastening shield, preferably wherein the fastening shield serves as a wall holder or ceiling holder, furthermore preferably wherein the fastening shield has bores for the ceiling or wall fastening.

25. The structural holder as claimed in claim 17, wherein a decorative sleeve or a canopy can be plugged or is plugged over the base unit and connections of the structural holder in such a manner that, by means of the decorative sleeve, the connections, which are formed by the connection wires, the cable clamps and the supply lines, can be concealed or are concealed by the decorative sleeve or the canopy.

26. The structural holder as claimed in claim 17, wherein the illuminant holder can be connected or is connected via the base unit to a fastening shield which preferably serves as a wall holder or ceiling holder, wherein preferably the illuminant holder can be latched or is latched into the base unit, furthermore preferably into the base or base plate of the base unit.

27. The structural holder as claimed in claim 17, wherein the base unit of said structural holder consists of a base or base plate, arms and a fastening shield, wherein the base or base plate has a cutout and flexible latching hooks for connecting to latching openings of the illuminant holder, and/or the fastening shield has bores for the ceiling fastening or wall fastening, and a cutout.

28. The structural holder as claimed in claim 23, wherein the flexible latching hooks have excess lengths and/or the fastening shield has a groove, which excess lengths and/or groove in each case individually or jointly fix the decorative sleeve, or, in the case of a canopy, the canopy is fixed between the ceiling or wall (or optionally alternatively the optionally additional ceiling covering or wall covering having a larger covering surface than the fastening shield; what is referred to as a hide), on the one hand, and the base plate, on the other hand, and is protected against slipping.

29. The structural holder as claimed in claim 17, wherein a defined distance is maintained between the ceiling or wall and that end of the structural holder or of the illuminant that is remote therefrom.

30. The structural holder as claimed in claim 17, wherein a threaded base with a decorative sleeve as a connection for decorative luminaires can be screwed into said structural holder.

31. A kit comprising a structural holder as claimed in claim 17, wherein, in addition to the structural holder or to the base unit, the kit comprises an additional ceiling covering or wall covering, wherein the additional ceiling covering or wall covering is mounted flush with a ceiling or wall, and wherein the additional ceiling covering or wall covering has a covering surface which is larger than the fastening shield.

32. An illuminant holder for a structural holder which is mounted flush with a ceiling or wall and serves for the temporary or permanent fastening of light fittings as claimed in claim 17, wherein the structural holder comprises a base unit, and wherein the illuminant holder is configured for connecting by the illuminant holder being plugged onto a base unit which is configured in such a manner that at least two connection wires present on site after the by the illuminant holder being plugged onto the base unit, after said connection wires are attached to the at least two supply lines via the individual cable clamps, can be looped, in particular tightly, around the base unit, preferably around a part of the base unit that is tapered in relation to the external dimensions.

33. The base unit as claimed in claim 18, characterized in that the base unit has a cutout in the base and a cutout in the fastening shield.

34. The base unit as claimed in claim 18, wherein the base unit has a cutout in the arm, preferably wherein said cutout corresponds to the cutout in the base and to the cutout in the fastening shield, furthermore preferably wherein the cutout in the arm forms an interior space in the arm, said interior space being open toward the cutout, particularly preferably wherein said open interior space in the arm is also open toward the base and toward the fastening shield.

35. The base unit as claimed in claim 18, wherein the base in the base unit is designed as a base plate.

36. The base unit as claimed in claim 18, wherein the base unit has an arm which, in the portion facing the base or the base plate, is tapered on the outer side in relation to the portion facing the fastening shield.
